(19) United States
(12) Patent Application Publication
(10) Pub. No.: US 2026/0319737 A1
(43) Pub. Date: Oct. 15, 2026

(54) CONTROL METHOD AND MEDIA OUPUT DEVICE

(71) Applicant: Lenovo (Beijing) Limited, Beijing (CN)

(72) Inventors: Hongwei LI, Beijing (CN); Lijun SU, Beijing (CN)

(21) Appl. No.: 19/465,893

(22) Filed: Jan. 30, 2026

Related U.S. Application Data
(63) Continuation of application No. PCT/CN2024/098904, filed on Jun. 13, 2024.

(30) Foreign Application Priority Data
Jul. 31, 2023 (CN) 202310953231.3

(51) Int. Cl. G06F 3/16; G06F 3/14

(52) U.S. Cl. CPC G06F 3/165; G06F 3/14

(57) ABSTRACT

A control method includes: when a media output device is at a first spatial orientation, outputting first display content corresponding to the first spatial orientation, and outputting first audio content corresponding to the first display content using a first audio parameter; obtaining parameter information representing a spatial orientation of the media output device; when the parameter information indicates that the media output device switches from the first spatial orientation to a second spatial orientation, at least based on the parameter information, causing the media output device to output second display content corresponding to the second spatial orientation, and outputting the first audio content using a second audio parameter, where the first display content is different from the second display content, and the first audio parameter is different from the second audio parameter.

### CROSS-REFERENCE TO RELATED APPLICATION(S)

This application claims priority to PCT International Application No. PCT/CN2024/098904 filed on Jun. 13, 2024, which in turn claims priority to Chinese Patent Application No. 2023109532313 filed on Jul. 31, 2023, both of which are incorporated herein by reference in their entireties.

### FIELD OF THE TECHNOLOGY

When a media output device outputs multiple display contents with audio contents, it may be difficult for the user to quickly identify which audio is corresponding to which display content, thus reducing the user experience.

### BACKGROUND

When a media output device outputs multiple display contents with audio contents, it may be difficult for the user to quickly identify which audio is corresponding to which display content, thus reducing the user experience.

### SUMMARY

In one aspect, the present disclosure provides a control method. The control method includes: when a media output device is at a first spatial orientation, outputting first display content corresponding to the first spatial orientation, and outputting first audio content corresponding to the first display content using a first audio parameter; obtaining parameter information representing a spatial orientation of the media output device; when the parameter information indicates that the media output device switches from the first spatial orientation to a second spatial orientation, at least based on the parameter information, causing the media output device to output second display content corresponding to the second spatial orientation, and outputting the first audio content using a second audio parameter, where the first display content is different from the second display content, and the first audio parameter is different from the second audio parameter.

In another aspect, the present disclosure provides an electronic device. The device includes: a memory storing computer program instructions; and a processor coupled to the memory and configured to execute the computer program instructions and perform: when a media output device is at a first spatial orientation, outputting first display content corresponding to the first spatial orientation, and outputting first audio content corresponding to the first display content using a first audio parameter; obtaining parameter information representing a spatial orientation of the media output device; when the parameter information indicates that the media output device switches from the first spatial orientation to a second spatial orientation, at least based on the parameter information, causing the media output device to output second display content corresponding to the second spatial orientation, and outputting the first audio content using a second audio parameter, where the first display content is different from the second display content, and the first audio parameter is different from the second audio parameter.

In yet another aspect, the present disclosure provides a non-transitory computer-readable storage medium storing computer program instructions executable by at least one processor to perform: when a media output device is at a first spatial orientation, outputting first display content corresponding to the first spatial orientation, and outputting first audio content corresponding to the first display content using a first audio parameter; obtaining parameter information representing a spatial orientation of the media output device; when the parameter information indicates that the media output device switches from the first spatial orientation to a second spatial orientation, at least based on the parameter information, causing the media output device to output second display content corresponding to the second spatial orientation, and outputting the first audio content using a second audio parameter, where the first display content is different from the second display content, and the first audio parameter is different from the second audio parameter.

### BRIEF DESCRIPTION OF THE DRAWINGS

To more clearly illustrate the technical solutions in certain embodiments of the present disclosure, the drawings for the description of certain embodiments are briefly introduced below. The drawings described below reflect certain embodiments of the present disclosure, and those skilled in the technical field may obtain other drawings based on the provided drawings without inventive effort.

FIG. 1 is a flowchart illustrating a control method provided in certain embodiments of the present disclosure;

FIG. 2 is a schematic diagram of a virtual display area corresponding to an AR/VR headset device provided in certain embodiments of the present disclosure;

FIG. 3 is a schematic diagram of a display area of an AR/VR headset device provided in certain embodiments of the present disclosure.

FIG. 4 is a schematic diagram of a second display content provided in certain embodiments of the present disclosure;

FIG. 5 is a schematic diagram of a second display content provided in certain embodiments of the present disclosure; and

FIG. 6 is a schematic diagram of a scenario provided in certain embodiments of the present disclosure.

### DETAILED DESCRIPTION

The technical solutions in certain embodiments of the present disclosure are described below in conjunction with the accompanying drawings. The described embodiments reflect certain embodiments of the present disclosure, and not all of them. Based on certain embodiments in the present disclosure, all other embodiments obtained by those skilled in the technical field without making creative efforts are within the scope of protection of the present disclosure.

The terms "first" and "second" are used for descriptive purposes only and should not be construed as indicating or implying relative importance or implicitly specifying the number of the indicated technical features. Thus, features qualified by "first" and "second" may explicitly or implicitly include one or more of such features. Furthermore, the terms "comprising" and "having," and any variations thereof, as used in the present disclosure, are intended to cover non-exclusive inclusion. For example, a process, method, system, product, or device that comprises a series of steps or modules is not limited to the listed steps or modules, but may optionally include other steps or modules not listed, or may optionally include other steps or modules inherent to such processes, methods, products, or devices.

In scenarios using media data, the media data may include image data, audio data, text data, or even composite data, such as video data that includes both image data and audio data. Correspondingly, media data may be output through media output devices. Because media output devices may have multiple functions, they may be adapted to a variety of implementation scenarios. In certain scenarios, the media output device may be an electronic device with a physical display screen and speakers, such as a laptop computer. In scenarios requiring particular displays, the media output device may be a projection device capable of large-screen display, or a VR (Virtual Reality) device or AR (Augmented Reality) device that allows users to experience three-dimensional display effects. In certain embodiments of the present disclosure, the media output device may include a device whose spatial orientation may be changed, or it may refer to a device connected to the media output device that may have different spatial orientations. For example, when the media output device is a laptop computer, a change in the spatial orientation of a wearable device communicating with the laptop computer may also be understood as a change in the spatial orientation related to that laptop computer. The change in spatial orientation may include changes in spatial coordinates, changes in spatial angles, changes in the spatial direction of particular components, or changes resulting from a combination of the above information. This change in the spatial orientation of the media output device may be achieved through control operations, or it may be a change in the spatial orientation of the media output device resulting from a change in the orientation of the object to which the media output device is attached. For example, the media output device may be a head-mounted device, and when the orientation of the user wearing the head-mounted device changes, the spatial orientation of the head-mounted device also changes.

When the media output device is a projection device with adjustable three-dimensional positioning, the three-dimensional positioning refers to the spatial positioning of the projection device. For example, the projection device may be configured in a certain position in space using movable components. The user may control the movement of these movable components through a remote control or other sensing components, thereby changing the position of the projection device in space. When a user changes the spatial position of the projection device using its control components, the spatial orientation of the projection device also changes. For example, when a user adjusts the distance between the projection device and the screen to control the image size, or adjusts the up, down, left, and right positions of the projection device to control the image position, the spatial orientation of the projection device relative to its initial position changes. In certain embodiments, when the projection device projects content onto a screen or blank wall, and the projected content is displayed in a split-screen format with at least one content area, the user may adjust the spatial position of the projection to change the position of the currently viewed image, similar to dragging and adjusting the image content.

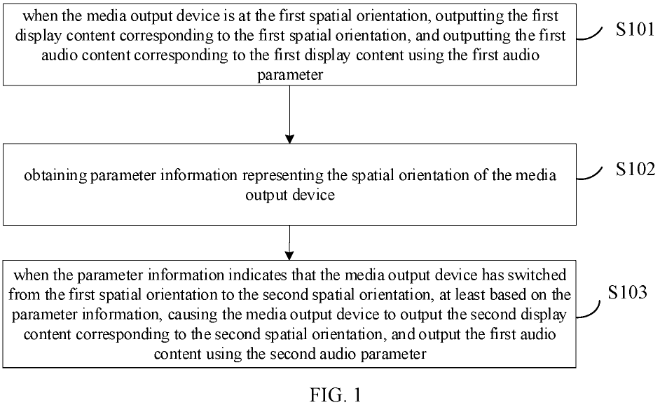

When the spatial orientation of the media output device changes, the displayed content that the user is focusing on may also change. However, when the audio output method corresponding to the displayed content remains unchanged, the user may not be able to quickly distinguish between the current displayed content and its corresponding audio content. In other words, the user may not be able to achieve a similar visual and auditory experience. For example, when the audio content corresponding to the image the user is focusing on is output at a low volume, the user may not be able to fully immerse themselves in that image and its corresponding audio content, and may be distracted by other louder audio, thus reducing the quality of the audio experience for the currently viewed image. Therefore, to solve this problem, the present disclosure in certain embodiments provides a control method that may be applied to media output devices, or to devices with control functions connected to media output devices. Referring to FIG. 1, which is a flowchart illustrating a control method provided in certain embodiments, the method may include:
S101. when the media output device is in the first spatial orientation, outputting the first display content corresponding to the first spatial orientation, and outputting the first audio content corresponding to the first display content using the first audio parameter.
S102. obtaining parameter information representing the spatial orientation of the media output device.
S103. when the parameter information indicates that the media output device has switched from the first spatial orientation to the second spatial orientation, at least based on the parameter information, causing the media output device to output the second display content corresponding to the second spatial orientation, and output the first audio content using the second audio parameter.

Taking AR/VR 3D display scenarios as an example, communication is typically established between a PC (Personal Computer) and the AR/VR headset device. The user experiences 3D visual effects through the AR/VR application on the PC. This PC-based AR/VR application facilitates data interaction and command transmission with the AR/VR headset device. For example, it may control the number of display areas in the AR/VR headset and the output of corresponding display content. In certain embodiments, the PC may receive data transmitted by the AR/VR headset using its own sensing or data acquisition components, and process and analyze this data to determine information such as the headset's orientation, status, and applicable display modes.

In certain embodiments of the present disclosure, a wearable headset device is used as an example of a media output device. In certain embodiments, it may be an AR headset device or a VR headset device. For ease of description, an AR/VR headset device is used as an illustration. In virtual reality interactive applications, at least one virtual display area located in three-dimensional space may be output through the AR/VR headset device. The display effect of each virtual display area is similar to the display effect of a physical screen commonly used in electronic devices, that is, each virtual display area is treated as a virtual display screen. This display mode may be called a virtual multi-screen display mode. In certain embodiments, AR/VR headset devices may create virtual display hardware information corresponding to the physical display hardware information, such as creating at least one virtual graphics card and a virtual display screen. The created virtual display hardware information, including the virtual graphics card and virtual display screen, may then be transmitted to the operation system via its display driver, allowing the operation system to recognize this virtual hardware information. Based on this virtual display hardware information, at least one virtual display area is created, enabling the corresponding content to be output to these virtual display areas.

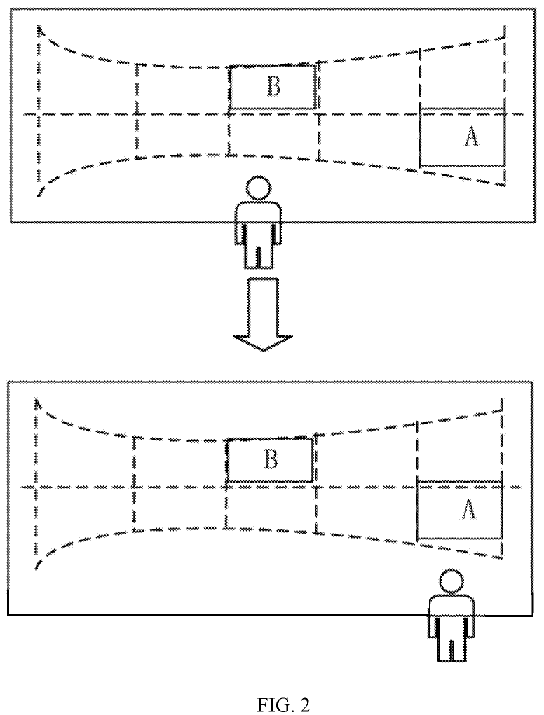

These virtual display areas may be placed spatially within the environment that the user may perceive through an AR/VR headset device. When the user wearing the AR/VR headset device moves, the position of these virtual display areas in the spatial area remains unchanged, but the virtual display areas that appear within the user's optimal field of view may differ. These virtual display areas may be distributed side-by-side within a 180-degree spatial area, or they may be distributed in a stereophonic surround manner within a 360-degree spatial area. Referring to FIG. 2, which is a schematic diagram of the virtual display area corresponding to an AR/VR headset device according to certain embodiments of the present disclosure, after the user wears the AR/VR headset device, the user may obtain the spatial display area corresponding to the curved area in FIG. 2. This spatial display area may have multiple virtual display areas arranged in a particular distribution manner, such as virtual display area A and virtual display area B. When the user wearing the AR/VR headset device is in the position shown in the upper part of FIG. 2, the virtual display area B mainly appears within the field of view. When the user moves to the position shown in the lower part of FIG. 2, the virtual display area A mainly appears within the field of view.

When each of these virtual display areas outputs its corresponding content, for example, when each virtual screen displays the content of its respective application—for example, one virtual display area outputs the video content of a video application, while another virtual display area outputs the surveillance content of a video surveillance application. However, when these virtual display areas output content that all includes audio, and all contents are output simultaneously, it becomes difficult for the user to distinguish which audio corresponds to which currently displayed content, or to distinguish which image corresponds to which audio. Therefore, in certain embodiments of the present disclosure, when displaying content corresponding to the spatial orientation of the media output device, the audio content corresponding to the displayed content is output using particular audio output parameter. For example, when the displayed content is no longer the first displayed content, the audio does not need to be output with an audio output effect that aligns with the display effect of the first displayed content. This ensures that the user experiences a similar and more consistent visual effect of the displayed content and auditory effect of the audio content, further enabling the user to align the displayed content with its corresponding audio content more quickly and conveniently.

When the media output device is in the first spatial orientation, as shown in the upper part of FIG. 2, then the first display content corresponding to the first spatial orientation may be output through the first interface of the media output device (such as the display content output interface), such as outputting the display content of display area B in FIG. 2, and the first audio content corresponding to the first display content is output using the first audio parameter, that is, the audio content corresponding to the display content in area B of FIG. 2 is output using the first audio parameter.

Taking media output devices as an example of wearable devices, the spatial orientation of the media output device may be determined by parameter information that represents its spatial orientation. This parameter information may be determined by the media output device itself or by the user of the media output device. For example, the parameter information may be user operation information for the media output device, or spatial posture parameter of the media output device, including its spatial position parameter and spatial orientation parameter, or even interaction information between the user and the media output device. When the parameter information is the spatial posture parameter of the media output device, and the media output device is an AR/VR headset device, since the user is wearing the AR/VR headset device, the spatial posture parameter of the AR/VR headset may be determined by information such as whether the user has moved and/or whether the user's head has rotated. For example, in FIG. 2, when the user wearing the AR/VR headset device moves to a different position, the spatial coordinates of the AR/VR headset device change, thus altering its spatial orientation. When the user's head rotates while wearing the AR/VR headset device, the orientation or angle of the AR/VR headset device relative to a certain reference system changes, thereby altering its spatial orientation.

When the parameter information indicates that the media output device switches from a first spatial orientation to a second spatial orientation, the media output device outputs the second display content corresponding to the second spatial orientation based at least on the parameter information, and outputs the first audio content using the second audio parameter, where the first display content is different from the second display content, and the first audio parameter is different from the second audio parameter. When determining the display content corresponding to the spatial orientation of the media output device based on parameter information, this is implemented in scenarios without particular settings. For scenarios where a particular process mode has been pre-configured, the corresponding display content is determined based on the setting requirement and the parameter information, and corresponding to the audio parameter of the audio content, the display content and its corresponding audio parameters are simultaneously determined according to identifier information and parameter information. This includes determining both the display content and the audio parameter of the corresponding audio content based on the corresponding identifier information and parameter information. The particular implementation method will be described in detail in subsequent embodiments of the present disclosure in conjunction with particular scenarios. Correspondingly, parameter information representing the spatial orientation of the media output device may be obtained through a parameter acquisition apparatus of the media output device (such as a sensor, eye-tracking module, or positioning module). This parameter information may then be identified and processed by the process unit of the media output device to determine the spatial information of the media output device corresponding to the current parameter information. In certain embodiments, the data acquisition device may transmit the collected parameter information to a control device (such as a PC connected to the media output device via a data communication interface) through the data transmission interface of the media output device. The control device then identifies and processes the parameter information to obtain the spatial orientation information of the media output device, and transmits this information back to the media output device, allowing the media output device to obtain its current spatial orientation. Referring to FIG. 2, the upper part of the image in FIG. 2 represents the first spatial orientation corresponding to the AR/VR headset device. At this time, it outputs at least the content of display area B, meaning that the user primarily sees the content of display area B through the AR/VR headset device. The AR/VR headset device may directly output the audio content of display area B using the first audio parameter, or it may output the audio content using the first audio parameter to an external speaker device connected to the AR/VR headset device through a second interface (such as an audio information output interface), so that the speaker device outputs the audio content using the first audio parameter. The lower part of the image in FIG. 2 represents the second spatial orientation corresponding to the AR/VR headset device. At this time, it outputs at least the content of display area A, meaning that the user primarily sees the content of display area A through the AR/VR headset device, and outputs the audio content corresponding to the content of display area B using the second audio parameter. For example, when the first displayed content is the content of display area B, it may be video content, and when the second displayed content is the content of display area A, it may be audiobook content. Since the first audio parameter is different from the second audio parameter, when the user is primarily focusing on the content of display area A, the audio content corresponding to the content of display area B may be output at a lower volume using the second audio parameter. This reduces interference from the audio content of display area B while the user is focusing on the content of display area A. In certain embodiments, when determining the first and second audio parameters for the first audio content, this may be based on the volume of the audio content playback, or it may be based on parameters such as the sound quality and sound effects during audio content playback. For example, when the media output device is at a first spatial orientation, the user may see the first display content and receive the first audio content output at a higher volume. When the media output device is at a second spatial orientation, the user may see the second display content, and the output volume of the first audio content is lower or zero. It should be noted that the content displayed to the user aligns with the spatial orientation of the media output device. Other content may also be continuously output and displayed, but simply not within the user's current field of view.

In certain embodiments of the present disclosure, when outputting display content corresponding to the spatial orientation of the media output device, the audio content corresponding to the display content is also output using corresponding audio parameter, allowing the user to obtain a similar visual and auditory experience. That is, when the display content is no longer aligned with the target content, the audio content or the audio parameter of the audio content will also no longer be aligned with the audio content of the target content. Furthermore, this allows the user to quickly align the viewed display content with the heard audio content, avoiding the problem of being unable to distinguish the sound in view of the image or the image in view of the sound, thereby improving the user experience.

In certain embodiments of the present disclosure, the user experience may be improved by adjusting the audio output parameter of the audio content corresponding to the display content that is not aligned with the current spatial orientation of the media output device. In certain embodiments, it may involve adjusting the audio output parameter of the audio content corresponding to the display content that is not aligned with the current spatial orientation, while also adjusting the audio output parameter of the audio content corresponding to the display content that aligns with the current spatial orientation. For example, when the media output device is at the second orientation, the volume of the first audio content is reduced, and the volume of the second audio content is increased. In certain embodiments, the method of causing the media output device to output the second display content corresponding to the second spatial orientation based at least on parameter information includes: causing the media output device to output the second display content corresponding to the second spatial orientation based at least on parameter information, and outputting the second audio content corresponding to the second display content using a fourth audio parameter. The fourth audio parameter is different from the third audio parameter. The third audio parameter represents the audio parameter of the second audio content corresponding to the second display content when the media output device is at the first spatial orientation. In certain embodiments, after the spatial orientation of the media output device is switched, the switching of different display content is achieved. In order to improve the user experience, the corresponding switching of different audio content is also achieved. In certain embodiments, when switching between audio content, the audio content displayed is switched based on audio parameter with better salience. For example, at the first spatial orientation, the first display content is output, and at this time, the first audio content is output using the first audio parameter. Correspondingly, the second audio content may also be output at this time, but the salience of the audio parameter of the second audio content is less than that of the first audio parameters. After determining the second display content corresponding to the second spatial orientation of the media output device, the audio parameter of the second audio content corresponding to the second display content may be adjusted to the fourth audio parameters, that is, using audio parameter with fewer audio effects to output the second audio content, so that the user may quickly and easily distinguish the audio content corresponding to the current display content. Furthermore, this fourth audio parameter may be the audio parameter that provides the best audio salience when the media output device is in the second spatial orientation. The fourth audio parameter may be determined based on the audio characteristics of the second audio content, or based on the display characteristics of the second display content corresponding to the second spatial orientation, or based on the proportion of the second display content within the corresponding content. Accordingly, to help optimize the user experience and minimize abrupt changes in the user's audio perception, the audio content corresponding to the displayed content based on the current spatial orientation of the media output device may be output with particular audio parameter that make it more salient than other audio content. For example, all audio content could be output at 90% volume. This helps ensure that even when the spatial orientation of the media output device changes, the audio content corresponding to the displayed content that the user is focusing on is always output at that volume, meaning the audio with the highest volume is always the audio corresponding to the displayed content the user is interested in, resulting in a better user experience.

When the spatial orientation of the media output device switches from a first spatial orientation to a second spatial orientation, the first audio content corresponding to the original first spatial orientation may no longer be output. That is, the second audio parameter includes audio parameter indicating that the first audio content is not being input. For example, when the audio parameter is volume, then the volume corresponding to the second audio parameter is zero, effectively silencing the first audio content. Correspondingly, when the second audio parameter is a volume parameter, it may also be a lower volume, significantly less than the volume corresponding to the current fourth audio parameter. In response to the media output device being at the second spatial orientation, at least the first audio content and the second audio content are output simultaneously. Furthermore, all audio content corresponding to the media output device may be output simultaneously, including the audio content corresponding to the displayed content in the current spatial orientation, and the audio content of the displayed content that does not correspond to the current spatial orientation.

Taking the example of a media output device outputting both the first audio content and the second audio content while at a second spatial orientation, in particular, when simultaneously outputting the first and second audio contents, the audio parameter corresponding to the first audio content is the second audio parameter, and the audio parameter corresponding to the second audio content is the fourth audio parameters. When simultaneously outputting the two audio contents mentioned above, the first audio content may be output using the audio track corresponding to the first audio content, and the second audio content may be simultaneously output using the audio track corresponding to the second audio content. For example, when simultaneously outputting the first audio content and the second audio content, the first speaker array may output the first audio content, and the second speaker array may output the second audio content. Furthermore, it is also possible to mix the first audio content and the second audio content for output. That is, the at least simultaneous output of the first audio content and the second audio content includes: in response to the at least simultaneous output of the first audio content and the second audio content, mixing the first audio content of the second audio parameter and the second audio content of the fourth audio parameters, and outputting the mixed first and second audio content. In this implementation, the first and second audio contents are mixed together before output. Mixing may be understood as integrating sounds from multiple sources into a single stereophonic or mono audio track, and processing them into mixed audio content for output. Mixing involves adjusting and balancing the relative levels (for example, volume) of different audio content, and includes various audio processing techniques such as equalization and compression applied to individual tracks, track groups, and the overall mix. In certain embodiments of the present disclosure, the volume value of the mixed first and second audio content may be determined based on the second and fourth audio parameters. Then, the mixing process is performed and the output is generated based on this volume value. In certain embodiments, it may also be determined as to whether to output the current audio contents simultaneously or as a mixed output based on the characteristics of the audio contents. For example, in scenarios requiring high-quality sound effects, different audio contents may be mixed and output. This is because the main function of mixing is to adjust the frequency response curve, applying different attenuation to different audio frequencies to adjust the timbre of the audio signal, resulting in better audio output.

Taking the scenario of connecting an AR/VR headset device to a PC as an example, the audio output of the PC's sound mixer interface may be controlled through the PC operation system. In certain embodiments, first, determine the process that outputs audio to the sound mixer interface when the AR/VR headset device is at its initial spatial orientation (such as the initial state). This process represents the execution unit of the application that generates the audio output. The application is the one that produces the audio, and in particular, the application capable of generating display content and corresponding audio content. Then, identify the window corresponding to this process. This window represents an interface of the running application, corresponding to the content output by the application. This content may include display content for display on the corresponding screen, as well as audio content output through the sound output device. After determining all the windows, the position of the display content corresponding to each window in the display area of the AR/VR headset device may be determined. This display area may include multiple virtual screens, each of which may be used to display a window corresponding to an application. When the user wears the AR/VR headset device, the sensing apparatus in the headset device tracks the user's gaze or head orientation to determine the virtual screen currently being viewed by the user, and records the position of that virtual screen. Accordingly, at least two virtual screens may be presented within the user's field of view. Furthermore, some virtual screens may only partially appear; at this time, the proportion of each virtual screen within the current field of view may be recorded.

Determine the window corresponding to each virtual display screen that appears within the user's field of view, thereby determining the display content corresponding to each virtual display screen. Then, find the intersection of the display content and the audio content corresponding to the audio process, that is, determine the display content corresponding to each virtual display screen and the audio content corresponding to that display content. This allows for determining the audio content corresponding to the display content within the user's current field of view, and generating control command that may control the audio output of the sound mixer interface, so that the sound mixer interface outputs the audio content corresponding to the control command. In certain embodiments, the audio mixer interface outputs audio content corresponding to the control command. It may be configured to only output the audio content of the virtual display screen within the user's field of view. Alternatively, based on the proportion of each virtual display screen within the user's current field of view, the audio parameters (such as volume) of the audio content corresponding to these virtual display screens may be set to a mixing ratio of 100% or a particular percentage, while the audio content corresponding to display content outside the field of view is set to 0%. It is also possible to allow the audio content of applications displaying content outside the user's field of view to be output at a lower volume. Furthermore, the sound mix ratio for the audio content of applications displaying content outside the user's field of view may be set to a predetermined ratio.

In addition to enabling users of media output devices to quickly identify the audio content corresponding to the displayed content they are interested in, or the displayed content corresponding to the current audio content, it also allows for changes in audio parameter differentiations within a particular range. This facilitates users in switching the spatial orientation of the media output device to change the currently viewed displayed content or audio content, resulting in a better user experience. In certain embodiments, by varying audio parameter differentiations in different ranges, users may experience stereophonic surround sound. when the content displayed by the current media output device may be distributed around the user in a stereophonic surround manner (for example,, a 360-degree display space), the audio parameter of the audio content corresponding to the displayed content within the user's current field of view may be made most salient, such as having the highest volume. The audio parameter of the audio content corresponding to other displayed content may be set to create an effect where the volume is louder for closer objects and quieter for farther objects, meaning the closer the displayed area is to the user, the louder the corresponding audio content will be, and vice versa. Furthermore, audio parameters may be determined based on the distance or sequence correlation between the display area the user is focusing on and other display areas. In certain embodiments, different ranges of audio parameter settings may be presented, such as setting the audio parameters for audio content in display areas closer to the display content corresponding to the current spatial orientation to be significantly different from the audio parameters for audio content in relatively farther display areas.

In certain embodiments, outputting the first audio content using the second audio parameter include: determining the second audio parameter based on the spatial orientation correlation between the first spatial orientation and the second spatial orientation, and outputting the first audio content using the second audio parameter. The spatial orientation correlation may characterize the degree of orientation change between the first and second spatial orientations. This may be determined by parameters such as the rotation angle, position coordinates, and direction angle of the media output device. Through the spatial orientation correlation, the correlation between the first and second display contents is determined, such as their relative display positions, allowing for differentiated settings of corresponding audio parameters.

Furthermore, determining the second audio parameter based on the spatial orientation correlation between the first spatial orientation and the second spatial orientation includes: determining the correlation between the first display area for outputting the first display content and the second display area for outputting the second display content based on the spatial orientation correlation between the first spatial orientation and the second spatial orientation; and determining the second audio parameter based on this correlation. Each display area may show corresponding display content, as shown in FIG. 2. When using an AR/VR headset as the output device, multiple display areas can exist within the spatial range; for example, display area B may show content B, and display area A may present content A. The display area corresponding to the user's field of view based on the current spatial orientation may be used to determine the correlation between the display areas before and after the spatial orientation switching of the AR/VR headset device. In certain embodiments, the correlation between display areas may include position correlation and sequence correlation. Position correlation refers to the spatial distribution of each display area, such as the distance and relative angle between two display areas. The corresponding display content may be output according to the positional distribution order, or the content may be randomly displayed in each display area. Sequence correlation refers to the sequence order of each display area set in the media output device's configuration file. Furthermore, it is also possible to set which display area each piece of display content is output to. For example, display areas arranged side by side within a spatial range may be numbered sequentially from 1 to 4 from left to right. When outputting display content, the content may also be output in that order, such as displaying the content of the first application opened by the user in the display area numbered 1.

In certain embodiments, when the correlation includes the position correlation between the first display area and the second display area, determining the second audio parameter based on the correlation includes: when the position correlation indicates that the distance between the first display area and the second display area is within a first range, determining the second audio parameter based on a first audio range, where when the media outputs the second display content corresponding to the second spatial orientation, the audio parameter of the second audio content corresponding to the second display content is significantly different from any audio parameter within the first audio parameter range, and the magnitude of the second audio parameter aligns with the magnitude of the distance between the two areas. When the position correlation indicates that the distance between the first display area and the second display area is within a second range, the second audio parameter is determined, and the second audio parameter indicates that no audio parameter of the first audio content is output.

In certain embodiments, the distance between the first display area and the second display area may be represented by the distance between the center points of the two display areas, or by the absolute distance between the two display areas. The parameter ranges corresponding to the first and second ranges may be determined based on the scenario, for example, by the size of the spatial range of the display area output by the media output device. The first range represents display area relatively closer to the display area corresponding to the current spatial orientation, while the second range represents display area relatively further away from the display area corresponding to the current spatial orientation. The display area corresponding to the current spatial orientation is the main display area; that is, when the current spatial orientation corresponds to at least one display area, the display area with the larger proportion is the main display area. Any audio parameter within the first audio parameter range may be an audio parameter with a lower volume, and the audio parameter corresponding to the second range may be audio parameter with zero volume.

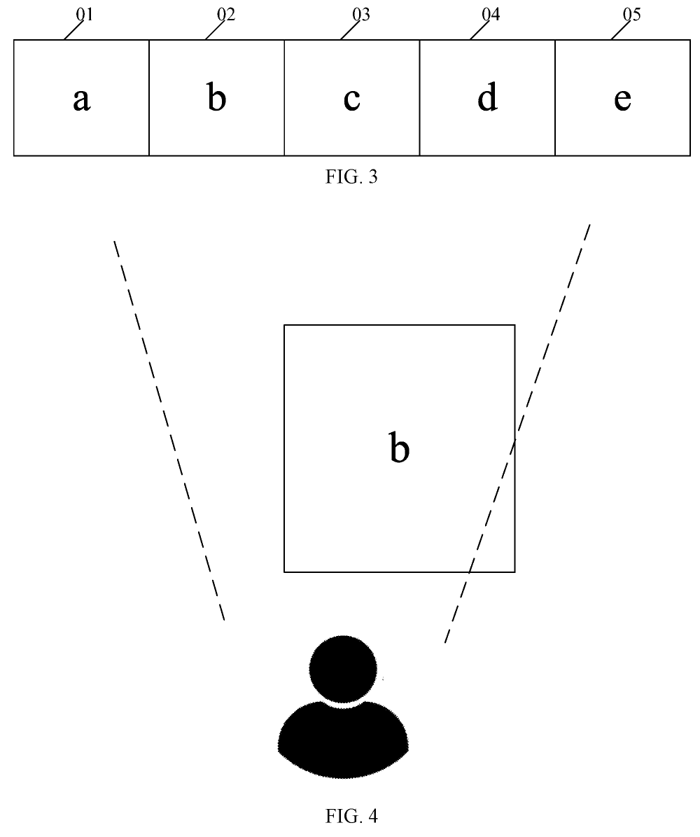

For example, when the media output device is an AR/VR headset device, the various display areas of its corresponding display space are shown in FIG. 3. In FIG. 3, the display areas are arranged side by side, including display area 01, display area 02, display area 03, display area 04, and display area 05. Display area 01 displays content a, display area 02 displays content b, display area 03 displays content c, display area 04 displays content d, and display area 05 displays content e. Based on the current spatial orientation of the AR/VR headset device, the display area visible within the user's field of view is display area 02. By analyzing the user's gaze parameter, it may be determined that the user is focusing on display area 02. Since display areas 01, 03, and 04 are relatively close to display area 02, the audio content corresponding to display content a, c, and d may be output at a lower volume. Display area 05 is further away from display area 02, so the audio content corresponding to display content e may be output in silent mode. Furthermore, since display area 04 is further from display area 02 than display area 03 is from display area 02, the volume of the audio content corresponding to display content d may be set lower than the volume of the audio content corresponding to display content c.

Correspondingly, the audio content of the displayed content corresponding to the current spatial orientation of the media output device may be output using audio parameter that provides better audio effects, such as outputting at a higher volume, while the audio content corresponding to other content that does not appear within the user's field of view, for example, content not corresponding to the current spatial orientation, is played in silent mode.

In another implementation, the audio parameter may also be determined based on the proportion of the displayed content. When the media output device is at a second spatial orientation and the displayed content is the second display content, in certain embodiments of the present disclosure, outputting the second audio content corresponding to the second display content using the fourth audio parameter includes: when the media output device outputs a portion of the second content as the second display content corresponding to the second spatial orientation, determining the fourth audio parameter based on the proportion of the second display content within the second content, and outputting the second audio content corresponding to the second display content using the fourth audio parameter. The second content may represent the entire content corresponding to the second displayed content. When the user is at the second orientation using the media output device, the displayed content viewed by the user is shown in FIG. 4 within the dashed line area, meaning that the user may see a relatively large portion of the displayed content b within the user's current field of view. When the displayed content b is fully displayed normally, the entire second content corresponding to it should be the content within the rectangular box. The fourth audio parameter may be determined by calculating the proportion of the area of the displayed content b within the current field of view to the area of the corresponding region in the rectangular box on the right. For example, when the proportion is 80%, the fourth audio parameter may be the audio parameter corresponding to that 80% proportion.

In the above embodiments, the determination of audio parameter aligned with the displayed content is described in the context of the display content corresponding to the current spatial orientation of the media output device being a single item, for example, the display content being the output of a single application. Below is a description of the situation where the display content corresponding to the current spatial orientation is not one.

Still using the determination of the fourth audio parameter for the second audio content as an example, in certain embodiments, outputting the second audio content corresponding to the second displayed content using the fourth audio parameter includes:
The second display content output by the media output device, corresponding to the second spatial orientation, includes at least a portion of the third content and at least a portion of the fourth content. Based on the proportion information corresponding to at least a portion of the third content and at least a portion of the fourth content, the fifth audio parameter corresponding to the third audio content and the sixth audio parameter corresponding to the fourth audio content are determined respectively;
The third audio content of the fifth audio parameter and the fourth audio content of the sixth audio parameter are output simultaneously.

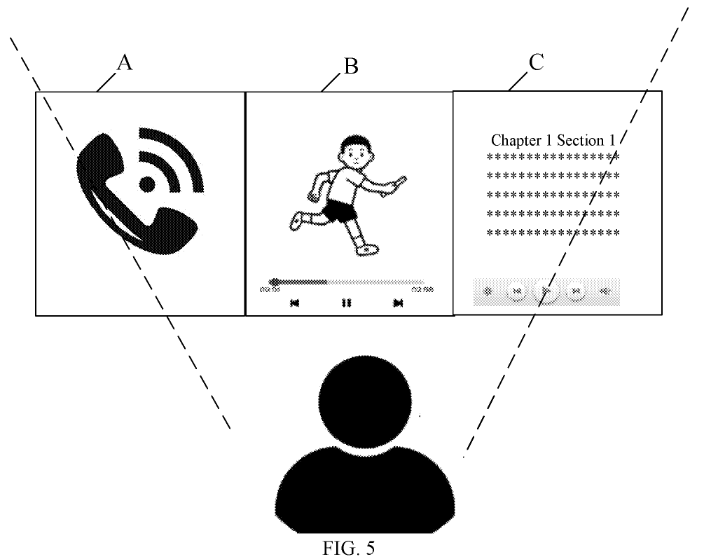

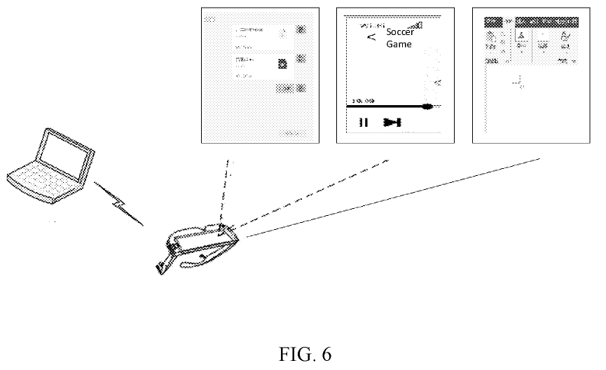

In certain embodiments, the second display content includes at least a portion of the third content and at least a portion of the fourth content. The proportion information may refer to the first proportion parameter representing the portion of the third content within the third content, and the second proportion parameter representing the portion of the fourth content within the fourth content; alternatively, it may refer to the proportion parameters representing the respective portions of the third and fourth content relative to their combined total. Furthermore, the second displayed content may also include other content, such as at least a portion of the fifth content. Alternatively, the second displayed content may include all of the third content and at least a portion of the fourth content. Referring to FIG. 5, when the media output device is at the second spatial orientation, the second displayed content within the user's field of view includes a portion of the third content (for example,, the content in display area A), a portion of the fourth content (for example,, the content in display area C), and all of the fifth content (for example,, the content in display area B). Then, the proportion of each content section within the current field of view may be calculated. Based on this proportion information, the audio parameters corresponding to the aforementioned contents may be determined. Taking audio volume as an example, when all the content in display area B is presented within the current field of view, its proportion is the largest, and the corresponding volume may be set to the highest level. The content in display area A and display area C, however, occupy a relatively smaller proportion within the field of view, so their corresponding volumes may be set to a level lower than that of display area B. Furthermore, when the content in display area A and the content in display area C occupy the same proportion within the field of view, the same volume may be set for output, or the corresponding volume may be determined by analyzing the content characteristics of each display area. For example, the content displayed in display area A is voice call content, the content displayed in display area B is video content, and the content displayed in display area C is the text content of an audiobook. By analyzing the content of each display area, since the call application only generates audio when a user makes a call, the audio parameter for the audio content in display area A may be set to the second highest value. For audiobooks, users may obtain the content through text, so the corresponding audio parameter may be set to the minimum value. Furthermore, when the proportion within the field of view is the same, the audio parameters corresponding to each content feature may also be determined based on the frequency with which the user uses each type of displayed content.

In this implementation, the displayed content corresponding to the current spatial orientation of the media output device includes a portion of certain content, or portions of multiple portions of content. This situation may occur because the user desires to view different content, or because the user is in the process of determining the content they need to focus on. When a user determines the content, they want to focus on by adjusting the spatial orientation of the media output device, to enhance the user experience, the audio parameters of the corresponding audio content may be determined in real time based on the proportion of the currently displayed content to the entire content. Taking audio parameters, in particular volume, as an example: when the currently displayed content is a video, and when the media output device is at the first spatial orientation, the current video frame occupies 70% of the original entire video frame, then the audio corresponding to this video is output at a volume of 70 (volume adjustment range is 0-100). Subsequently, when the user moves the media output device to the second spatial orientation, and the current video frame occupies 85% of the original entire video frame, then the audio corresponding to this video is output at a volume of 85 (volume adjustment range is 0-100). Finally, when the user moves the media output device to the third spatial orientation, and the current video frame occupies 95% of the original entire video frame, then the audio corresponding to this video is output at a volume of 95 (volume adjustment range is 0-100). This allows for a gradual adjustment of the volume based on the proportion, making the audio parameter switching process more natural and smoother, thus improving the user experience.

Accordingly, to avoid repeatedly adjusting audio parameters and increasing processing resource consumption, when the user determines the content they want to focus on by adjusting the spatial orientation of the media output device, and the currently displayed content is the entire content of the corresponding content, the audio content of that displayed content will not be output until the spatial orientation of the media output device remains unchanged for a certain period of time, or the current displayed content is the entire content of the corresponding content, at which point the audio content of that displayed content will be output using the corresponding audio parameter.

The above embodiments illustrate the process of processing various display contents and corresponding audio contents in certain scenarios. The present disclosure also includes processing methods for particular scenarios, such as when certain content is pre-configured with identifier information. When using the methods described above, the processing of the content corresponding to this identifier information may be considered, in order to broaden the applicability of the control method provided in the present disclosure.

In certain embodiments of the present disclosure, the method of causing the media output device to output second display content corresponding to a second spatial orientation based at least on parameter information, and to output first audio content using second audio parameter, includes: causing the media output device to output second display content corresponding to the second spatial orientation based on parameter information and identifier information, and to output first audio content using second audio parameter. The identifier information may represent information related to the identification of displayed content, or it may represent information related to the identification of audio content. When obtaining this identifier information, the configuration information of the present disclosure corresponding to each displayed content may be obtained through an application configuration file, thereby determining the corresponding identifier information. Alternatively, the identifier information may be determined by analyzing the current display content or audio content. when the identifier information is determined by an audio output identifier, and the audio output identifier has a higher priority, then regardless of whether the display content corresponding to that audio output identifier is within the display range corresponding to the current state of the media output device, it will be output using more salient audio parameters, such as at a higher volume. When the identifier information is determined by the display output identifier, the display content corresponding to the higher-priority display output identifier is displayed within the display range corresponding to the current spatial orientation of the media output device.

In certain embodiments, the identifier information includes an audio output identifier, where outputting the first audio content using the second audio parameter includes: when a first audio output identifier corresponding to the first audio content exists, outputting the first audio content using the first audio parameter; when a first audio output identifier corresponding to the first audio content does not exist, outputting the first audio content using the second audio parameter. For example, the first audio content is background music, and its corresponding audio output identifier has a higher priority. This means that regardless of the spatial orientation of the media output device, the background music is output using more salient audio parameter. The audio parameter may be determined through the configuration information corresponding to the audio output identifier. For instance, when the configuration information indicates a higher priority, the audio may be output using fixed and/or more salient audio parameter, such as the first audio parameter. In certain embodiments, the audio parameter of the first audio content may be determined based on the audio parameter of the display content corresponding to the current spatial orientation of the media output device. For example, when the media output device is at a second spatial orientation, the volume corresponding to the audio parameter of the first audio content may be slightly less than the volume corresponding to the audio parameter of the second audio content, but the volume corresponding to the audio parameters of the first audio content is greater than the volume corresponding to the audio parameter of other audio content. When there is no first audio output identifier corresponding to the first audio content, then the processing is performed according to the control method provided in certain embodiments of the present disclosure, that is, the spatial orientation of the media output device is determined based on the parameter information, and then the display content and the audio parameter of the audio content corresponding to the display content are determined based on the spatial orientation. For example, when the first audio content does not have a first audio output identifier, the first audio content is output using the second audio parameter.

In certain embodiments, the identifier information includes a display output identifier, where the media output device outputs the second display content corresponding to the second spatial orientation based on the parameter information and the identifier information, and outputs the first audio content using the second audio parameter, including:
when there is a first display output identifier corresponding to the first display content, the media output device outputs the second display content corresponding to the second spatial orientation based on the parameter information and the first display output identifier, where the second display content includes at least a portion of the first display content.

This display output identifier may represent identifier information indicating that the corresponding display content follows the spatial orientation of the media output device. That is, display content with this display output identifier is displayed within the display range corresponding to the current spatial orientation of the media output device. In certain embodiments, the second display content is the screen content within the display range corresponding to the current spatial orientation. This screen content may include content from a single application or content from different applications. For example, the second display content may include the video screen from a video application, or it may include portions of the video screen from a video application and the book screen from an audiobook application, or the like. Because the first display content has a first display output identifier, at least a portion of the first display content is always part of the displayed image corresponding to the current spatial orientation of the media output device. In certain embodiments, since at least a portion of the first display content is part of the second display content, when the media output device is at the second spatial orientation, when there is no display output identifier at this time, the display content determined according to the second spatial orientation is the second content. Furthermore, when the first display content has a corresponding first display output identifier, at least a portion of the first display content is determined as part of the second display content based on configuration information, that is, at least a portion of the first display content and the second content are combined to form the second display content, and then the second display content is output. In this way, when the second display content is displayed, it is equivalent to also outputting the first display content. Therefore, the first audio content is always output using audio parameter of higher salience. At least a portion of the first display content may be part of the information of the first display content, such as the title bar information of the first display content, or it may be processed in a particular display format, such as displaying the first display content in a small window, a floating window, or other ways.

In the above embodiments, parameter information and identifier information are used to determine the current spatial orientation of the media output device, as well as the display content and audio content corresponding to the identifier information. This process mode may be applied to scenarios where audio does not need to be output in real-time synchronization with the video, such as setting an audio output identifier for the audio content corresponding to a communication application. This allows the user to continue a voice call without displaying the voice call interface content within the user's current field of view, and instead consistently output the voice call content using optimal audio parameter. This avoids the problem of missing voice calls that may occur when the audio for content not corresponding to the current spatial orientation is silenced when only parameter information is configured to determine the display content. Correspondingly, this implementation method may also be used to achieve background audio playback. For example, when an audio output identifier is set for a particular audio content, it may output that audio content in real time with relatively salient audio parameter. However, the application or mini program that generates this audio content does not need to be displayed in the corresponding display area; it may simply run in the background and output the audio content.

The display output identifier may be obtained through configuration information, or determined by analyzing the current display content and its corresponding audio content. Certain embodiments also include: obtaining correlation between the first display content and the first audio content; when the correlation meets the target condition, generating a display output identifier for the first display content, where the target condition indicates that the first display content does not change with changes in the first audio content. In certain embodiments, the screen displaying the first display content may not be changing in real time, where real-time change refers to each video frame changing relative to a video stream output. For example, the first display content is the interface content of a browser, and the first audio content is music playback content obtained through searching in the browser. In this scenario, the display output identifier of the browser may be set, and its corresponding identifier may be output as part of the display content corresponding to the current spatial orientation of the media output device. At this time, the corresponding music playback content may always be output using relatively salient audio parameters.

The present disclosure in certain embodiments also provides a media output device, including:
an acquisition unit, configured to obtain parameter information, where the parameter information may determine the spatial orientation related to the media output device;
an output unit, configured to output display content corresponding to the spatial orientation, and audio content corresponding to the display content;
a process unit, configured to generate a first process signal corresponding to a first spatial orientation and a second process signal corresponding to a second spatial orientation. The first process signal is configured to control the output device to output first display content corresponding to the first spatial orientation and output first audio content corresponding to the first display content using first audio parameter; the second process signal is configured to control the output device to output second display content corresponding to the second spatial orientation and output the first audio content using second audio parameter;
where the first display content is different from the second display content, and the first audio parameter is different from the second audio parameter.

In certain embodiments, the media output device may be a wearable device, such as a VR headset device or an AR headset device, or the like. Correspondingly, the media output device may also include:
a wearable component, configured to maintain the position correlation between the media output device and at least a part of the user's body;
where, the acquisition unit includes a sensing subunit, configured to collect parameter information representing the spatial orientation of the media output device;
The output device includes a display subunit and a speaker, the display subunit is configured to display content corresponding to the spatial orientation, and the speaker is configured to play audio content corresponding to the display to the display content;
where, the first process signal generated by the process unit is configured to control the display subunit to display the first audio content corresponding to the first spatial orientation, and to control the speaker to play the first audio content corresponding to the first display content using first audio parameter, the second process signal generated by the process unit configured to control the display subunit to display the display content corresponding to the second spatial orientation, and to control the speaker to play the first audio content using second audio parameter.

In certain embodiments, the media output device may also be a process device with processing capabilities and data transmission and communication functions, such as a laptop computer. In this scenario, the media output device may communicate with the wearable device. See FIG. 6, which is a schematic diagram of a scenario provided in certain embodiments of the present disclosure. In FIG. 6, the media output device is a laptop computer, and the wearable device is AR/VR glasses. In this scenario, the media output device also includes:
a communication unit, configured to establish a communication connection with a wearable device; where the acquisition unit includes an acquisition subunit, configured to receive parameter information representing the spatial orientation of the wearable device;
where the output unit includes a transmission subunit, configured to transmit display content corresponding to the spatial orientation, and audio content corresponding to the display content, to the wearable device;
where, the first process signal generated by the process unit is configured to control the transmission subunit to transmit the first display content corresponding to the first spatial orientation to the wearable device, and to transmit the first audio content corresponding to the first display content to the wearable device using the first audio parameters; the second process signal generated by the process unit is configured to control the transmission subunit to transmit the second display content corresponding to the second spatial orientation to the wearable device, and to transmit the first audio content to the wearable device using the second audio parameter.

In certain embodiments, the process flow of the process unit of the media output device may be seen in the relevant processes for determining the display content and audio parameters in the control method provided in certain embodiments of the present disclosure, and relevant description is not repeated here for brevity.

In certain embodiments of the present disclosure, a readable storage medium is also provided, on which a computer program is stored. When the computer program is executed by a processor, it implements the control method described in any one of the above embodiments.

In certain embodiments of the present disclosure, an electronic device is also provided, which may include:
a memory for storing programs and data generated by the execution of the programs;
a processor for executing the programs to implement the control method described in any one of the above embodiments.

It should be noted that description of the particular implementation of the processor in certain embodiments may be found in the corresponding content in the foregoing description, and relevant description is not repeated here for brevity.

The various embodiments are described, with each embodiment focusing on the differences from other embodiments. Similar or identical parts between certain embodiments may be referred to by cross-referencing. For the devices disclosed in certain embodiments, since it corresponds to the method disclosed in certain embodiments, the description is relatively simple; relevant details may be found in the description of the method.

Those skilled in the technical field appreciate that the components and algorithmic steps of the examples described in the present disclosure may be implemented in electronic hardware, computer software, or a combination of both. To illustrate the interchangeability of hardware and software, the components and steps of each example have been generally described in terms of their functionality in the above description. Whether these functions are implemented in hardware or software depends on the particular implementation and design constraints of the technical solution. Those skilled in the technical field may use different methods to implement the described functions for each particular implementation, but such implementations are considered within the scope of the present disclosure.

The steps of the methods or algorithms described in certain embodiments disclosed in the present disclosure may be directly implemented by hardware, software modules executed by a processor, or a combination of both. The software modules may be stored in random access memory (RAM), memory, read-only memory (ROM), electrically programmable ROM, electrically erasable programmable ROM, registers, hard disk, removable disk, CD-ROM, or any other form of storage medium known in the technical field.

The above description of the disclosed embodiments enables those skilled in the technical field to make or use the present disclosure. Various modifications to these embodiments may be readily apparent to those skilled in the technical field, and the general principles defined herein may be implemented in other embodiments without departing from the spirit or scope of the present disclosure. Therefore, the present disclosure is not limited to certain embodiments shown herein, but is to be accorded the broadest scope consistent with the principles and novel features disclosed herein.

What is claimed is:

1. A control method, comprising:
when a media output device is at a first spatial orientation, outputting first display content corresponding to the first spatial orientation, and outputting first audio content corresponding to the first display content using a first audio parameter;
obtaining parameter information representing a spatial orientation of the media output device;
when the parameter information indicates that the media output device switches from the first spatial orientation to a second spatial orientation, at least based on the parameter information, causing the media output device to output second display content corresponding to the second spatial orientation, and outputting the first audio content using a second audio parameter,
wherein the first display content is different from the second display content, and the first audio parameter is different from the second audio parameter.

2. The method of claim 1, wherein causing the media output device to output the second display content includes:
causing the media output device to output the second display content corresponding to the second spatial orientation based at least on the parameter information, and outputting the second audio content corresponding to the second display content using a fourth audio parameter, wherein the fourth audio parameter is different from a third audio parameter, the third audio parameter representing an audio parameter of the second audio content corresponding to the second display content when the media output device is at a first spatial orientation.

3. The method of claim 2, further comprising:
in response to the media output device being at a second spatial orientation, simultaneously outputting at least the first audio content and the second audio content;
wherein, simultaneously outputting at least the first audio content and the second audio content includes:
in response to simultaneously outputting at least the first audio content and the second audio content, mixing the first audio content of the second audio parameter and the second audio content of the fourth audio parameter, and outputting a mixed first and second audio content.

4. The method of claim 1, wherein outputting the first audio content using the second audio parameter includes:
determining the second audio parameter based on a spatial orientation correlation between the first spatial orientation and the second spatial orientation, and outputting the first audio content using the second audio parameter.

5. The method of claim 4, wherein determining the second audio parameter based on the spatial orientation correlation between the first spatial orientation and the second spatial orientation includes:
determining a correlation between a first display area for outputting the first display content and a second display area for outputting the second display content, based on the spatial orientation correlation between the first spatial orientation and the second spatial orientation; and
determining the second audio parameter based on the correlation.

6. The method of claim 5, wherein the correlation includes a position correlation between the first display area and the second display area, and determining the second audio parameter based on the correlation includes:
when the position correlation indicates that a distance between the first display area and the second display area is within a first range, determining the second audio parameter based on a first audio parameter range, wherein when the media output device outputs the second display content corresponding to the second spatial orientation, the audio parameter of the second audio content corresponding to the second display content is different from any audio parameter within the first audio parameter range, and a magnitude of the second audio parameter aligns with a magnitude of the distance between the two areas;
when the position correlation indicates that the distance between the first display area and the second display area is within a second range, determining the second audio parameter, wherein the second audio parameter indicates that the audio content of the first audio content is not output.

7. The method of claim 2, wherein outputting the second audio content corresponding to the second display content using the fourth audio parameter includes:
when the media output device outputs the second display content corresponding to the second spatial orientation as a portion of the second content, determining the fourth audio parameter based on the proportion of the second display content within the second content; and
outputting the second audio content corresponding to the second display content using the fourth audio parameter.

8. The method of claim 2, wherein outputting the second audio content corresponding to the second display content using the fourth audio parameter includes:
in response to the second display content output by the media output device corresponding to the second spatial orientation including at least a portion of the third content and at least a portion of the fourth content, determining a fifth audio parameter of the third audio content corresponding to the third content and a sixth audio parameter of the fourth audio content corresponding to the fourth content, respectively, based on proportion information corresponding to at least a portion of the third content and at least a portion of the fourth content; and
simultaneously outputting the third audio content of the fifth audio parameter and the fourth audio content of the sixth audio parameter.

9. The method of claim 1, wherein causing the media output device to output the second display content corresponding to the second spatial orientation and output the first audio content using the second audio parameter, based on the parameter information, includes:
causing the media output device to output the second display content corresponding to the second spatial orientation and output the first audio content using the second audio parameter, based on the parameter information and identifier information.

10. The method of claim 9, wherein the identifier information includes an audio output identifier, and wherein outputting the first audio content using the second audio parameter includes:
when a first audio output identifier corresponding to the first audio content exists, outputting the first audio content using the first audio parameter; and
when a first audio output identifier corresponding to the first audio content does not exist, outputting the first audio content using the second audio parameter.

11. The method of claim 9, wherein the identifier information includes a display output identifier, and wherein causing the media output device to output the second display content includes:
when there is a first display output identifier corresponding to the first display content, causing the media output device to output the second display content corresponding to the second spatial orientation based on the parameter information and the first display output identifier, wherein the second display content includes at least a portion of the first display content.

12. An electronic device, comprising: a memory storing computer program instructions; and a processor coupled to the memory and configured to execute the computer program instructions and perform:
when a media output device is at a first spatial orientation, outputting first display content corresponding to the first spatial orientation, and outputting first audio content corresponding to the first display content using a first audio parameter;
obtaining parameter information representing a spatial orientation of the media output device;
when the parameter information indicates that the media output device switches from the first spatial orientation to a second spatial orientation, at least based on the parameter information, causing the media output device to output second display content corresponding to the second spatial orientation, and outputting the first audio content using a second audio parameter,
wherein the first display content is different from the second display content, and the first audio parameter is different from the second audio parameter.

13. The electronic device of claim 12, wherein causing the media output device to output the second display content includes:
causing the media output device to output the second display content corresponding to the second spatial orientation based at least on the parameter information, and outputting the second audio content corresponding to the second display content using a fourth audio parameter, wherein the fourth audio parameter is different from a third audio parameter, the third audio parameter representing an audio parameter of the second audio content corresponding to the second display content when the media output device is at a first spatial orientation.

14. The electronic device of claim 13, wherein the processor is further configured to execute the computer program instructions and perform:
in response to the media output device being at a second spatial orientation, simultaneously outputting at least the first audio content and the second audio content;
wherein, simultaneously outputting at least the first audio content and the second audio content includes:
in response to simultaneously outputting at least the first audio content and the second audio content, mixing the first audio content of the second audio parameter and the second audio content of the fourth audio parameter, and outputting a mixed first and second audio content.

15. The electronic device of claim 12, wherein outputting the first audio content using the second audio parameter includes:
determining the second audio parameter based on a spatial orientation correlation between the first spatial orientation and the second spatial orientation, and outputting the first audio content using the second audio parameter.

16. The electronic device of claim 15, wherein determining the second audio parameter based on the spatial orientation correlation between the first spatial orientation and the second spatial orientation includes:
determining a correlation between a first display area for outputting the first display content and a second display area for outputting the second display content, based on the spatial orientation correlation between the first spatial orientation and the second spatial orientation; and
determining the second audio parameter based on the correlation.

17. The electronic device of claim 16, wherein the correlation includes a position correlation between the first display area and the second display area, and determining the second audio parameter based on the correlation includes:
when the position correlation indicates that a distance between the first display area and the second display area is within a first range, determining the second audio parameter based on a first audio parameter range, wherein when the media output device outputs the second display content corresponding to the second spatial orientation, the audio parameter of the second audio content corresponding to the second display content is different from any audio parameter within the first audio parameter range, and a magnitude of the second audio parameter aligns with a magnitude of the distance between the two areas;
when the position correlation indicates that the distance between the first display area and the second display area is within a second range, determining the second audio parameter, wherein the second audio parameter indicates that the audio content of the first audio content is not output.

18. The electronic device of claim 13, wherein outputting the second audio content corresponding to the second display content using the fourth audio parameter includes:
when the media output device outputs the second display content corresponding to the second spatial orientation as a portion of the second content, determining the fourth audio parameter based on the proportion of the second display content within the second content; and
outputting the second audio content corresponding to the second display content using the fourth audio parameter.

19. The electronic device of claim 13, wherein outputting the second audio content corresponding to the second display content using the fourth audio parameter includes:
in response to the second display content output by the media output device corresponding to the second spatial orientation including at least a portion of the third content and at least a portion of the fourth content, determining a fifth audio parameter of the third audio content corresponding to the third content and a sixth audio parameter of the fourth audio content corresponding to the fourth content, respectively, based on proportion information corresponding to at least a portion of the third content and at least a portion of the fourth content; and
simultaneously outputting the third audio content of the fifth audio parameter and the fourth audio content of the sixth audio parameter.

20. A non-transitory computer-readable storage medium storing computer program instructions executable by at least one processor to perform:
when a media output device is at a first spatial orientation, outputting first display content corresponding to the first spatial orientation, and outputting first audio content corresponding to the first display content using a first audio parameter;
obtaining parameter information representing a spatial orientation of the media output device;
when the parameter information indicates that the media output device switches from the first spatial orientation to a second spatial orientation, at least based on the parameter information, causing the media output device to output second display content corresponding to the second spatial orientation, and outputting the first audio content using a second audio parameter,
wherein the first display content is different from the second display content, and the first audio parameter is different from the second audio parameter.
